(19) United States
(12) Patent Application Publication
(10) Pub. No.: US 2006/0259303 A1
(43) Pub. Date: Nov. 16, 2006

(54) Systems and methods for pitch smoothing for text-to-speech synthesis

(76) Inventor: Raimo Bakis, Briarcliff Manor, NY (US)

Correspondence Address: F. CHAU & ASSOCIATES, LLC, 130 WOODBURY ROAD, WOODBURY, NY, 11797, US

(21) Appl. No.: 11/128,003

(22) Filed: May 12, 2005

(51) Int. Cl. G10L 13/06

(52) U.S. Cl. 704/268

(57) ABSTRACT

TTS synthesis systems are provided which implement computationally fast and efficient pitch contour smoothing methods for determining smooth pitch contours for non-smooth pitch contours, which closely track the non-smooth pitch contours. For example, a TTS method includes generating a sequence of phonetic units representative of a target utterance, determining a pitch contour for the target utterance, the pitch contour comprising a plurality of linear pitch contour segments, wherein each linear pitch contour segment has start and end times at anchor points of the pitch contour, filtering the pitch contour to determine pitch values of a smooth pitch contour at the anchor points, and determining the smooth pitch contour between adjacent anchor points by linearly interpolating between the pitch values of the smooth pitch contour at the anchor points.

### TECHNICAL FIELD

The present invention relates generally to TTS (Text-To-Speech) synthesis systems and methods and, more particularly, systems for methods for smoothing pitch contours of target utterances for speech synthesis.

### BACKGROUND

In general, TTS synthesis involves converting textual data (e.g., a sequence of one or more words) into an acoustic waveform which can be presented to a human listener as a spoken utterance. Various waveform synthesis methods have been developed and are generally classified as articulatory synthesis, formant synthesis and concatenative synthesis methods. In general, articulatory synthesis methods implement physical models that are based on a detailed description of the physiology of speech production and on the physics of sound generation in the vocal apparatus. Formant synthesis methods implement a descriptive acoustic-phonetic approach to synthesis, wherein speech generation is performed by modeling the main acoustic features of the speech signal.

Concatenative TTS systems construct synthetic speech by concatenating segments of natural speech to form a target utterance for a given text string. The segments of natural speech are selected from a database of recorded speech samples (e.g., digitally sampled speech), and then spliced together to form an acoustic waveform that represents the target utterance. The use of recorded speech samples enables synthesis of an acoustic waveform that preserves the inherent characteristics of real speech (e.g., original prosody (pitch and duration) contour) to provide more natural sounding speech.

Typically, with concatenative synthesis, only a finite amount of recorded speech samples are obtained and the database may not include spoken samples of various words of the given language. In such instance, speech segments (e.g., phonemes) from different speech samples may be segmented and concatenated to synthesize arbitrary words for which recorded speech samples do not exist. For example, assume that the word “cat” is to be synthesized. If the database does not include a recorded speech sample for the word “cat”, but the database includes recorded speech samples of the words “cap” and “bat”, the TTS system can construct “cat” by combining the first half of “cap” with the second half of “bat.”

But when small segments of natural speech arising from different utterances are concatenated, the resulting synthetic speech may have an unnatural-sounding prosody due to mismatches in prosody at points of concatenation. Indeed, depending on the amount and variety of recorded speech samples, for example, the TTS system may not be able to find speech segments that are contextually similar such that the prosody may be mismatched at concatenation points between speech segments. If such segments are simply spliced together with no further processing, an unnatural sounding speech would occur due to acoustic distortions at the concatenation points.

### SUMMARY OF THE INVENTION

Exemplary embodiments of the invention generally include TTS synthesis systems that implement methods for smoothing pitch contours of target utterances for speech synthesis. Exemplary embodiments of the invention include computationally fast and efficient pitch contour smoothing methods that can be applied to determine smooth pitch contours for non-smooth pitch contours, which closely track the non-smooth pitch contours.

In one exemplary embodiment of the invention, a method for speech synthesis includes generating a sequence of phonetic units representative of a target utterance and determining a pitch contour for the target utterance. The pitch contour is a linear pitch contour which comprises a plurality of linear pitch contour segments, wherein each linear pitch contour segment has start and end times at anchor points of the pitch contour.

In one exemplary embodiment, the pitch contour may be determined by predicting pitch and duration values by processing text data corresponding to the sequence of phonetic units using linguistic text analysis methods. In another exemplary embodiment, the pitch value at each anchor point is determined by sampling an actual pitch contour of a sequence of concatenated speech waveform segments representative of the sequence of phonetic units at the anchor points, and then determining the pitch value at each anchor point using the actual pitch values. In yet another exemplary embodiment, the pitch values at the anchor points may be determined using the actual pitch values and/or estimated pitch values.

A filtering process is applied to the pitch contour to determine the pitch values of a smooth pitch contour at the anchor points. In one exemplary embodiment of the invention, filtering comprises convolving the linear pitch contour with a double exponential kernel function, which enables the convolution integral to be determined analytically. Indeed, instead of using computationally expensive numeric integration to compute the convolution integral, the computation of the convolution integral is performed using an approximation where the integral is broken into portions that are integrated analytically, so that the computation requires only a small number of operations to compute smooth pitch values at anchor points in the linear pitch contour. Thereafter, the portions of the smooth pitch contour between the anchor points are then determined by linearly interpolating the values of the smooth pitch contour between the anchor points.

An acoustic waveform representation of the target utterance is then determined using the smooth pitch contour. In one exemplary embodiment using concatenative synthesis, the smooth pitch contour closely tracks and does not deviate to far from the actual pitch contour of a sequence of concatenated waveform segments representing the target utterance. In this manner, spectral pitch smoothing can be applied to the pitch contour of the speech waveform segments without degrading the naturalness, but rather maintaining, the inherent prosody characteristics of the acoustic waveforms of the concatenated speech segments.

These and other embodiments, aspects, features and advantages of the present invention will be described or become apparent from the following detailed description of exemplary embodiments, which is to be read in connection with the accompanying drawings.

### BRIEF DESCRIPTIONS OF THE DRAWINGS

FIG. 1 is a high-level block diagram that schematically illustrates a speech synthesis system according to an exemplary embodiment of the invention.

FIG. 2 is a flow diagram illustrating a speech synthesis method according to an exemplary embodiment of the invention.

FIG. 3 is a flow diagram illustrating a method for generating a pitch contour for speech synthesis, according to an exemplary embodiment of the invention.

FIG. 4 is an exemplary graphical diagram that illustrates an initial pitch contour generated for a sequence of concatenated speech segments.

FIG. 5 is a graphical diagram that illustrates a kernel function that is implemented for pitch contour smoothing according to an exemplary embodiment of the invention.

FIG. 6 is an exemplary graphical diagram that illustrates a smooth pitch contour that is determined by applying a pitch contour smoothing process to the initial pitch contour of FIG. 4 using the exemplary kernel function of FIG. 5.

### DETAILED DESCRIPTION OF EXEMPLARY EMBODIMENTS

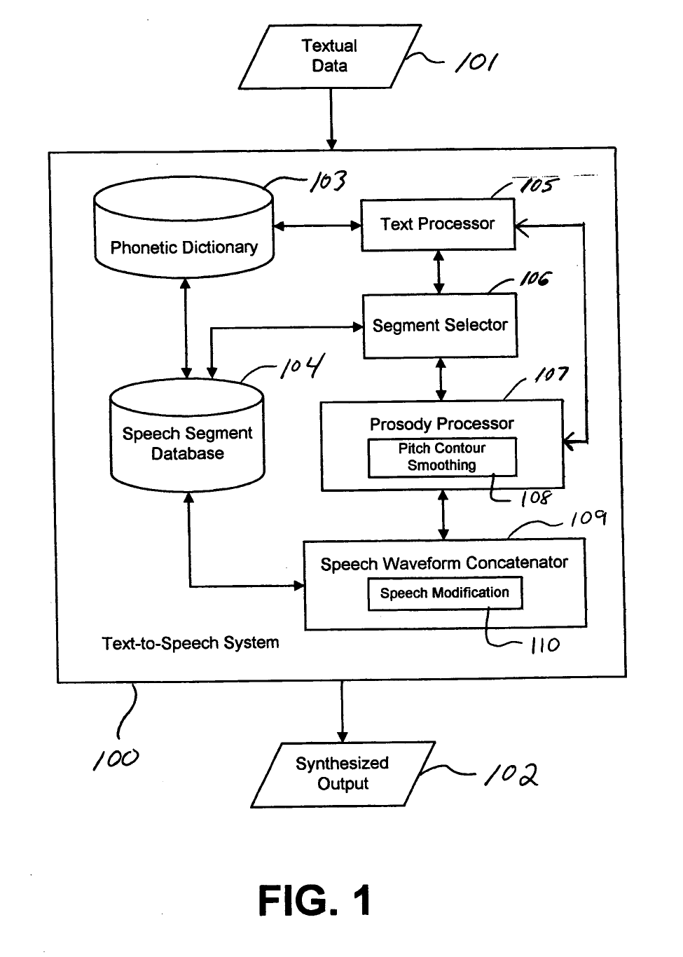

FIG. 1 is a high-level block diagram that schematically illustrates a speech synthesis system according to an exemplary embodiment of the invention. In particular, FIG. 1 schematically illustrates a TTS (text-to-speech) system (100) that receives and processes textual data (101) to generate a synthesized output (102) in the form of an acoustic waveform comprising a spoken utterance of the text input (101). In general, the exemplary TTS system (100) comprises a phonetic dictionary (103), a speech segment database (104), a text processor (105), a speech segment selector (106), a prosody processor (107) including a pitch contour smoothing module (108), and a speech segment concatenator (109) including a pitch modification module (110).

In the exemplary embodiment of FIG. 1, the various components/modules of the TTS system (100) implement methods to provide concatenation-based speech synthesis, wherein speech segments of recorded spoken speech are concatenated to form acoustic waveforms corresponding to a phonetic transcription of arbitrary textual data that is input to the TTS system (100). As explained in further detail below, the exemplary TTS system (100) implements pitch contour smoothing methods that enable fast and efficient smoothing of discontinuous, non-smooth pitch contours that are obtained from concatenation of the speech segments. Exemplary methods and functions implemented by components of the TTS system (100) will be explained in further detail below.

It is to be understood that the systems and methods described herein in accordance with the present invention may be implemented in various forms of hardware, software, firmware, special purpose processors, or a combination thereof. The present invention may be implemented in software as an application comprising program instructions that are tangibly embodied on one or more program storage devices (e.g., magnetic floppy disk, RAM, CD Rom, DVD, ROM and flash memory), and executable by any device or machine comprising a suitable architecture. It is to be further understood that because the constituent system modules and method steps depicted in the accompanying Figures may be implemented in software, the actual connections between the system components (or the flow of the process steps) may differ depending upon the manner in which the application is programmed. Given the teachings herein, one of ordinary skill in the related art will be able to contemplate these and similar implementations or configurations of the present invention.

In general, the text processor (105) includes methods for analyzing the textual input (101) to generate a phonetic transcription of the textual input. In one exemplary embodiment, the phonetic transcription comprises a sequence of phonetic descriptors or symbols that represent the sounds of the constituent phonetic units of the text data. The type of phonetic units implemented will vary depending on the language supported by the TTS system, and will be selected to obtain significant phonetic coverage of the target language as well as a reasonable amount of coarticulation contextual variation, as is understood by those of ordinary skill in the art. For example, the phonetic units may comprise phonemes, sub-phoneme, diphones, triphones, syllables, half-syllables, words, and other known phonetic units. Moreover, a combination of two or more different types of speech units may be implemented.

The text processor (105) may implement various natural language processing methods known to those of ordinary skill in the art to process text data. For example, the text processor (105) may implement methods for parsing the text data to identify sentences and words in the textual data and transform numbers, abbreviations, etc., into words. Moreover, the text processor (105) may implement methods to perform morphological/contextual/syntax/prosody analysis to extract various textual features regarding part-of-speech, grammar, intonation, text structure, etc. The text processor (105) may implement dictionary based methods using phonetic dictionary (103) and/or rule based methods to process the text data and phonetically transcribe the text data.

In general, the phonetic dictionary (103) comprises a phonological knowledge base (or lexicon) for the target language. In particular, the phonetic dictionary (103) may comprise a training corpus of words of a target language which contain all phonetic units (e.g., phonemes) of the target language. The training corpus may be processed using known techniques to build templates (models) of each phonetic unit of the target language. For example, in one exemplary embodiment of the invention, the phonetic dictionary (103) contains an entry corresponding to the pronunciation of each word or sub-word unit (e.g., morpheme) within the training corpus. Each dictionary entry may comprise a sequence of phonemes and/or sub-phoneme units, which form a word or sub-word. The dictionary entries may be indexed to other meta information such as descriptors (symbolic and prosody descriptors) corresponding to various types of textual features that are extracted from the text data via the text processor (105).

The text processor (105) outputs a phonetic transcription which comprises sequence phonetic descriptors of the phonetic units (e.g., phonemes) representative of the input text data. The phonetic transcription may be segmented such that the phonetic units are grouped into syllables, sequences of syllables, words, sequences of words, etc. The phonetic transcription may be annotated with descriptors corresponding to the various types of textual feature data extracted from the text string, as determined by the text processor (105).

The segment selector (106) receives the phonetic transcription and then selects for each phonetic unit, or groups of phonetic units, one or more candidate speech waveform segments from the speech segment database (104). In one exemplary embodiment, the speech segment database (104) comprises digital recordings (e.g., PCM format) of human speech samples of spoken sentences that include the words of the training corpus used to build the phonetic dictionary (103). These recordings may include corresponding auxiliary signals, for example, signals from an electro-glottograph to assist in determining the pitch. The recorded speech samples data are indexed in individual phonetic units (e.g., phonemes and/or sub-phoneme units) by phonetic descriptors. In addition, the recorded speech samples may be indexed to speech descriptors corresponding to various types of speech feature data that may be extracted from the recorded speech samples during a training process. The speech waveform segment database (104) is populated with data that is collected when training the system.

The recorded speech samples can be processed using known signal processing techniques to extract various types of speech feature data including prosodic information (pitch, duration, amplitude) of the recorded speech samples, as a function of time. More specifically, in one exemplary embodiment of the invention, each word in the recorded spoken sentences are expanded into constituent speech waveform segments of phonetic units (e.g., phonemes and/or sub-phoneme units), and the recorded speech samples are time-aligned to corresponding text of the recorded speech samples using known techniques, such as the well known Viterbi method, to generate time-aligned phonetic-acoustic data sequences. The time alignment is performed to find the times of occurrence of each phonetic unit (speech waveform segment) including, for example, start and end times of phonemes and/or time points of boundaries between sub-phoneme units within a given phoneme, etc. In addition, the time-aligned phonetic-acoustic data sequences can be used to determine pitch time marks including time points for pitch pulses (peak pitch) and pitch contour anchor points, etc.

In this manner, the speech waveform segments in the waveform database (104) can be indexed by various descriptors/parameters with respect to, e.g., phonetic unit identity, phonetic unit class, source utterance, lexical stress markers, boundaries of phonetic units, identify of left and right context phonetic units, phoneme position within a syllable, phoneme position within a word, phoneme position within an utterance, peak pitch locations, and prosody parameters such as duration, pitch (Fo), power and spectral parameters. The speech waveform segments can be provided in parametric form such as a temporal sequence of feature vectors.

The speech segment selector (106) implements methods known to those of ordinary skill in the art to select speech waveforms segments in speech segment database (104) which can be concatenated to provide an optimal sequence of speech segments in which discontinuities in pitch, amplitude, etc., are minimized or non-existent at concatenation points. More specifically, by way of example, the speech segment selector (106) may implement methods for searching the speech waveform segment database (104) to identify candidate speech waveform segments which have high context similarity with the corresponding phonetic units in the phonetic transcription. Phoneme/subphoneme-sized speech segments, for example, can be extracted from the time aligned phonetic-acoustic data sequences and concatenated to form arbitrary words.

The candidate speech segments are selected to minimize the prosody mismatches at concatenation points (e.g., mismatches in pitch and amplitude), which can result in acoustic waveform irregularities such as pitch jumping and fast transients at the concatenation points. The candidate speech segments can be concatenated to form one or more candidate speech segment sequences representative of the target utterance. The pitch contours of the candidate speech segment sequences can be evaluated using cost functions to determine an optimal sequence of concatenated speech segments having a pitch contour in which prosody mismatches between the speech segments are minimized (e.g., find the sequence having the least cost). The speech segment selector (106) generates an ordered list of descriptors representative of the selected sequence of speech waveform segments which are to be concatenated into the target utterance.

The prosody processor (107) implements methods for determining pitch contours for a target utterance. For instance, the prosody processor can implement methods for predicting/estimating a pitch contour for a target utterance based on the sequence of phonetic units and textual feature data as determined by the text processor (105). More specifically, the prosody processor (107) may implement one or more known rule-based or machine learning-based pitch contour predicting methods (such as those used in formant synthesis, for example) to determine duration and pitch sequences for the target utterance based on the context of the phonetic sequence, as well as stress, syntax, and/or intonation patterns, etc., for the target utterance as determined by the text processor (105).

It is to be appreciated that the predicted pitch contour for the target utterance includes prosody information that can be used by the segment selector (106) to search for candidate speech waveform segments having similar contexts with respect to prosody. In other exemplary embodiments, the predicted pitch contour can be used for pitch contour smoothing methods, as explained in further detail below.

The prosody processor (107) comprises methods for smoothing the pitch contours for target utterances to be synthesized. Since the speech segment selector (106) can concatenate speech waveform segments extracted from different words (different contexts), the boundaries of speech segments may have mismatched pitch values or spectral characteristics, resulting in audible discontinuities and fast transients where adjacent speech segments are joined. Such raw concatenation of the actual speech segments without further signal processing would result in degraded speech quality. Although the TTS system may be designed to select an optimal sequence of speech waveform segments to minimize prosody discontinuities, the ability to determine an optimal sequence of concatenated speech segments with minimal or no prosody discontinuities will vary depending on, e.g., the accuracy of the selection methods used, the words of the target utterance to be synthesized, and/or the amount and contextual variability provided by the corpus of speech waveform segments in the database. Indeed, a large number of speech waveform segment samples enable selection and concatenation of speech waveform segments with matching contexts. The types of segment selection methods used and the amount of recorded waveform segments that can be stored (together with relevant speech feature data) will vary depending on the available resources (processing power, storage, etc.) of the host system.

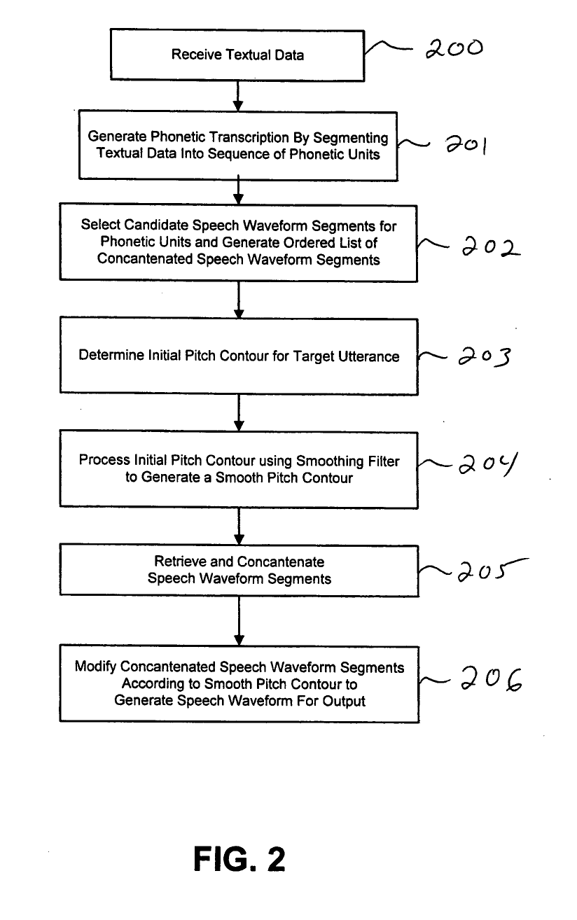

The prosody processor (107) comprises a pitch smoothing module (108) which implements computationally fast and efficient methods for smoothing the pitch contour corresponding to the sequence of concatenated speech waveform segments. The pitch smoothing module (108) includes methods for determining an initial (linear) pitch contour (pitch as a function of time) for the sequence of speech waveform segments by linear interpolating pitch values of the actual pitch contour between anchor points. This process is performed using prosodic data indexed to the speech segments, including pitch levels, peak pitch time markers, starting/ending time markers for each speech segment, time points at boundaries between phonemes, and anchor points within speech segments that identify changes in sound within the speech segment. The pitch contour smoothing module (108) applies a smoothing filter to the initial, non-smooth pitch contour to determine a new pitch contour which is smooth, but which tracks the initial, non-smooth pitch contour of the sequence of concatenated speech segment string as close as possible to thereby minimize distortion due to signal processing when the actual pitch contours of the concatenated speech segments are modified to fit the smooth pitch contour. Details regarding exemplary smoothing methods which may be implemented will be discussed in detail below with reference to FIGS. 2˜6.

The speech waveform segment concatenator (109) implements methods for generating an acoustic waveform for the target utterance by adjusting the actual pitch contour of the sequence of selected speech waveform segments to fit the smooth pitch contour. More specifically, the speech waveform segment concatenator (109) queries the speech segment database to obtain the speech waveform segments and prosody parameters, for each speech segment selected by the segment selector, and concatenates the speech waveform segments in the specified order. The speech waveform concatenator (109) performs known concatenation-related signal processing methods for concatenating speech segment waveforms and modifying the pitch of concatenated speech segments according to the smooth pitch contour. For example, known PSOLA (pitch synchronous overlap-add) methods may be used to directly concatenate the selected speech waveform segments in the time domain and adjust the pitch of the speech segments to fit the smoothed pitch contour previously determined.

FIG. 2 is a flow diagram that illustrates a method for generating synthesized speech according to an exemplary embodiment of the invention. FIG. 2 illustrates an exemplary mode of operation of the TTS system (100) of FIG. 1. Initially, textual data is input to the TTS system (step 200). The textual data is processed to generate a phonetic transcription by segmenting the textual data into a sequence of phonetic units (step 201). As noted above, the textual data may be segmented into phonetic units such as phonemes, sub-phoneme units, diphones, triphones, syllables, demisyllables words, etc., or a combination of different types of phonetic units. The phonetic transcription may comprise a sequence of phonetic descriptors (acoustic labels/symbols) annotated with descriptors which represent features derived from the text processing such as, lexical stress, accents, part-of-speech, syntax, intonation patterns, etc. In another exemplary embodiment of the invention, the phonetic transcription and related text feature data may be further processed to predict the pitch contour for the target utterance.

Next, the speech segment database is searched to select candidate speech waveform segments for the phonetic unit representation of the target utterance, and an ordered list of concatenated speech waveform segments is generated using descriptors of the candidate speech waveform segments (step 202). As discussed above, the speech waveform segment database comprises recorded speech samples that are indexed in individual phonetic units by phonetic descriptors, as well as other types of descriptors for speech features extracted from the recorded speech samples (e.g., prosodic descriptors such as duration, amplitude, pitch, etc., and positional descriptors, such as time points that mark peak pitch values, boundaries between phonetic units, statistically determined pitch anchor points for phonetic units, word position, etc.) Moreover, the prosody information of a predicted pitch contour for the target utterance can be used to search for speech waveform segments having similar contexts with respect to prosody. As noted above, various methods may be implemented to select the speech waveforms segments that provide an optimal sequence of concatenated speech segments, which minimizes discontinuities in pitch, amplitude, etc., at concatenation points.

It is to be understood that depending on the content of the recorded speech sample, the speech waveform segments selected may include complete words or phrases. Moreover, the speech segments may include word components such as syllables or morphemes, which are comprised of one phonetic unit or a string of phonetic units. For example, if the word “cat” is to be synthesized, and a recorded speech sample of the word “cat” is included in the phonetic transcription and in the speech waveform database, the recorded sample “cat” will be selected as a candidate speech waveform segment. If the database does not include a recorded speech sample for the word “cat”, but recorded speech samples of the words “cap” and “bat” are present in the database, the TTS system can construct “cat” by combining the first half of “cap” with the second half of “bat.”

As noted above, the actual pitch contour for the sequence of concatenated speech waveform segments may include discontinuities in pitch at concatenation points between adjacent speech segments. Such discontinuities may exist between adjacent words, syllables, phonemes, etc., comprising the sequence of speech waveform segments. To eliminate or minimize such discontinuities, a smoothing process according to an exemplary embodiment of the invention can be applied to smooth the pitch contour of the concatenated speech waveform segments. The smoothing process may be applied to the entire sequence of speech segments, or one or more portions of the sequence of speech segments. For instance, if a portion of the sequence of concatenated speech segments includes a relatively long phrase (e.g., 3 or more words) having matching context (e.g., the phrase corresponds to a recorded sequence of spoken words in the speech segment database), the original pitch contour of the phrase may be used for synthesis without smoothing. In such instance, smoothing may only be needed at the beginning and end regions of the phrase when concatenated with other speech segments with mismatched contexts to smooth pitch discontinuities at the concatenation points.

In general, referring to FIG. 2, a smoothing process includes determining an initial pitch contour for the target utterance (step 203) and processing the initial pitch contour using a smoothing filter to generate a smooth pitch contour (step 204). The initial pitch contour comprises a plurality of linear pitch contour segments each having a start time and end time at an anchor point. A smooth pitch contour is generated by applying a smoothing filter to the initial pitch contour, wherein filtering comprises convolving the initial pitch contour with a suitable kernel function.

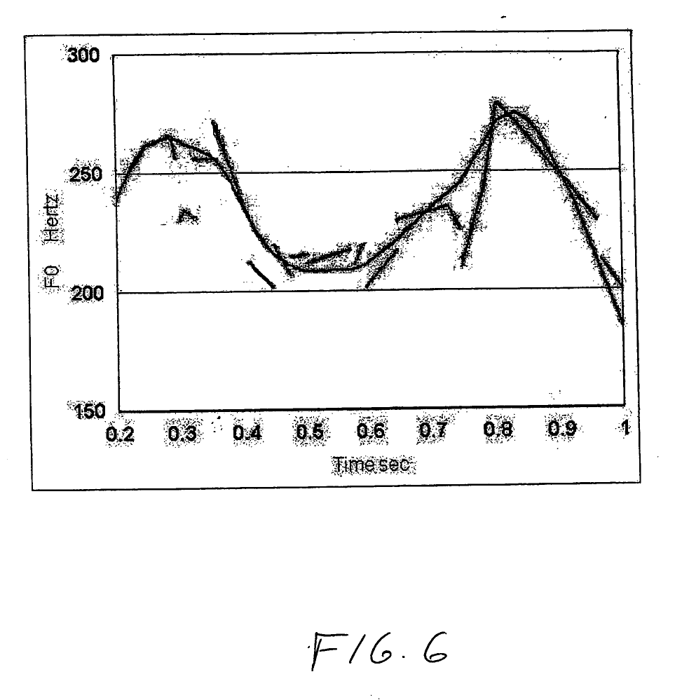

In one exemplary embodiment of the invention, a smooth pitch contour can be generated from a non-smooth, discontinuous pitch contour by convolving the non-smooth pitch contour with a double exponential kernel function of the form:
h(τ)=e^{-|τ|/τ}^{_{c}} (1)
wherein τₑ is the time constant. The exemplary kernel function of Equation (1) is depicted graphically in the exemplary diagram of FIG. 5. In FIG. 5, the horizontal axis is calibrated in units equal to the time constants. Assuming that f(t) denotes the original (actual) pitch contour of the sequence of concatenated speech waveform segments as a function of time, a smooth pitch contour, g(t), can be generated by convolving the pitch contour f(t) with the exemplary kernel function h(r) as follows:

$$g ( t ) = {\int }_{- ∞}^{∞} f ( t - τ ) h ( τ ) ⅆ τ . \qquad ( 2 )$$

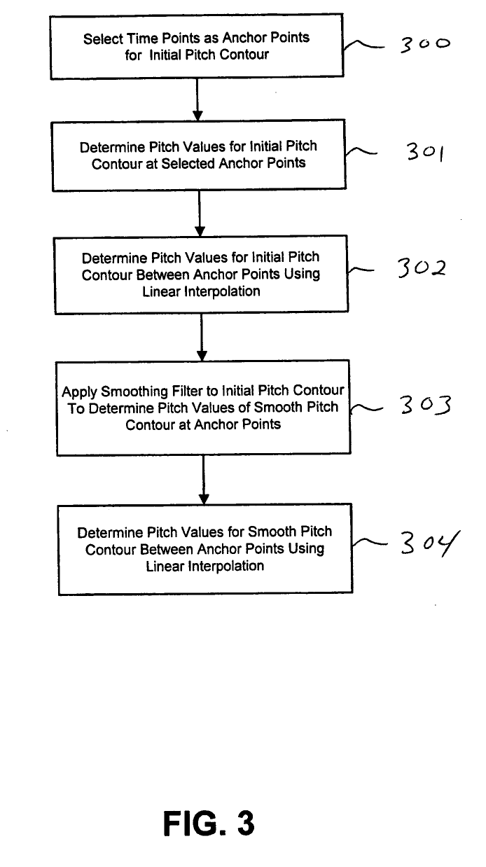

Instead of using computationally expensive numeric integration to compute the convolution integral, g(t), the original pitch contour f(t) is converted to a linear representation (step 203) to enable the convolution integral (Equation 2) to be determined analytically. As explained in detail below, the computation of the convolution integral (Equation 2) is performed using an approximation where the integral is broken into portions that are integrated analytically, so that the computation requires only a small number of operations to compute smooth pitch values at anchor points in the initial pitch contour. The smooth pitch contour is then determined by linearly interpolating the values of the smooth pitch contour between the anchor points. Exemplary methods for determining a smooth pitch contour will be explained in further detail below with reference to FIGS. 3-6, for example.

Once the smooth pitch contour is determined, the actual speech waveform segments will be retrieved from the speech waveform database and concatenated (step 205). The original pitch contour associated with the concatenated speech waveform segments will be modified according to the smooth pitch contour to generate the acoustic waveform for output (step 206). Exemplary pitch smoothing methods according to the invention yield smooth pitch contours which closely track the original pitch contour of the speech segments to thereby minimize distortion due to signal processing when modifying the pitch of the speech segments.

FIG. 3 is a high-level flow diagram that illustrates a method for smoothing a pitch contour according to an exemplary embodiment of the invention. The method of FIG. 3 can be used to implement the pitch smoothing method generally described above with reference steps 203˜204 of FIG. 2. Referring to FIG. 3, a method for determining an initial pitch contour according to an exemplary embodiment comprises, in general, selecting certain time points in the original pitch contour as anchor points (step 300), determining pitch values at the selected anchor points (step 301) and determining pitch values between the selected anchor points using linear interpolation (step 302).

In one exemplary embodiment of the invention, the anchor points are selected (step 300) as time points at boundaries between phonetic units of the target utterance to be synthesized. For example, in one exemplary embodiment of the invention where the text data is transcribed into a sequence of phonemes and/or sub-phoneme units, the anchor points will include time points at the start and end times for each phoneme segment, as well as time points at boundaries between sub-phoneme segments within each phoneme segment, such that each phoneme segment will have two or more anchor points associated therewith.

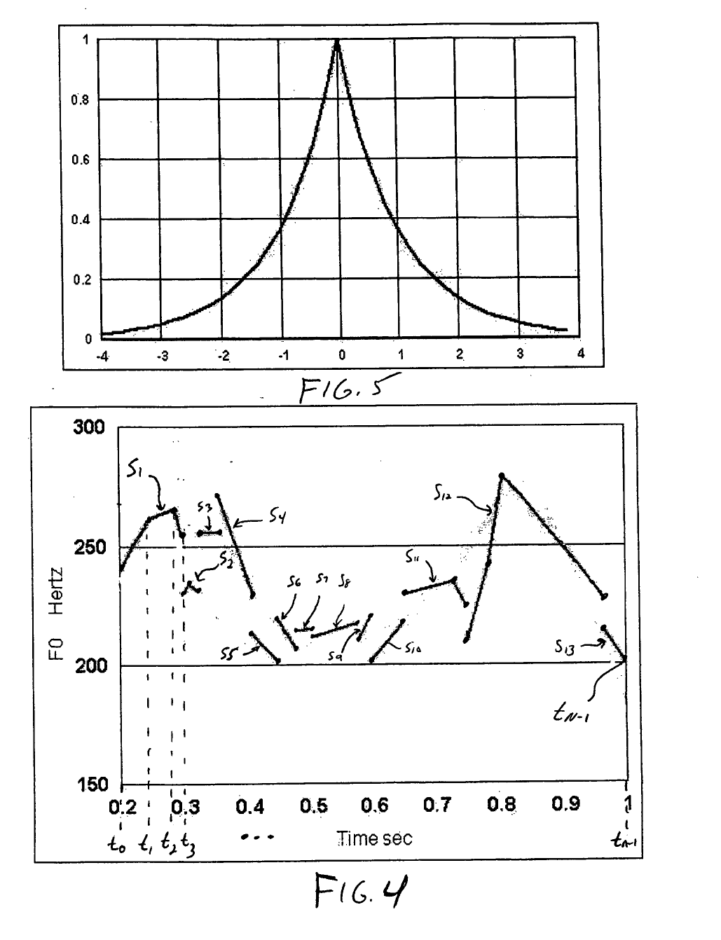

By way of example, FIG. 4 graphically illustrates an exemplary pitch contour comprising a plurality of linear pitch contour segments between adjacent anchor points. In particular, FIG. 4 depicts a linear pitch contour (fundamental frequency, F₀) as a function of time (for a time period of 0.2˜1.0 seconds) for a plurality of concatenated speech segments S₁˜S₁₃, and a plurality of time points, t₀,t₁,t₂,t₃ . . . tₙ₋₁, that are selected as anchor points for the initial pitch contour. It is to be understood that the speech segments S₁˜S₁₃ may represent individual phonemes, groups of phonemes (e.g., syllables), words, etc., within a target utterance to be synthesized. Moreover, the anchor points may represent time points at boundaries between phonemes of words, boundaries between sub-phonemes within words and/or boundaries between words. For example, segment S₁ may be a phoneme segment having pitch values at anchor points at tₒ, t₁, t₂ and t₃, wherein the start and end times of the phoneme segment S₁ are at t₀ and t₃, respectively, and wherein the segment S₁ is segmented into three sub-phoneme units with boundaries between the sub-phoneme units at t₁ and t₂ within the phoneme segment.

The selection of the anchor points will vary depending on the type(s) of phonetic units (e.g., phonemes, diphones, etc.) implemented for the given application. The anchor points may include time points at peak pitch values, and other relevant time points within a phoneme, syllable, diphones, or other phonetic units, which are selected to characterize points at which changes/transitions in sound occur. In one exemplary embodiment of the invention, the pitch anchors are determined from statistical analysis of the recorded speech samples during a training process and indexed to the speech waveform segments in the database.

Once the anchor points are selected (step 300), a pitch value is determined for each anchor point of the initial pitch contour (step 301). In one exemplary embodiment, the pitch values at the anchor points can be determined by sampling the pitch values of the actual pitch contour of the concatenated speech waveform segments at the anchor points. More specifically, in one exemplary embodiment, the pitch information (e.g., pitch values at anchor points) indexed with the selected speech waveform segments are used to determine the pitch values of the anchor points of initial pitch contour as a function of time. In another exemplary embodiment of the invention, the anchor points and pitch values at anchor points of an initial contour can be determined from the a predicted/estimated pitch contour of the target utterance as determined using prosody analysis methods. In other exemplary embodiments of the invention, the pitch values at the anchor points may be determined based on a combination (average or weighed measure) of predicted pitch values and actual pitch values.

When the pitch values are determined for the anchor points of the initial pitch contour (step 301), the remainder of the initial pitch contour in each time segment between adjacent anchor points is determined by linearly interpolating between the specified pitch values at the adjacent anchor points (step 302). In other words, each portion of the initial pitch contour in the time segments between adjacent anchor points is linearly interpolated between the pitch values at the anchor points. FIG. 4 illustrates an initial pitch contour for the sequence of concatenated segments S₁˜S₁₃, where the initial pitch contour comprises linearly interpolated segments between adjacent anchor points. By way of example, the pitch contour of speech segment S₁ comprises a linear pitch contour segment in each time segment t₀-t₁, t₁-t₂ and t₂-t₃.

In general, a linear pitch contour segment of the initial pitch contour in a segment between tᵢ₋₁ and tᵢ is expressed as:
\hat{f}ᵢ(t)=aᵢ+bᵢ t (3).
In one exemplary embodiment of the invention, the constants aᵢ and bᵢ for a given linear pitch contour segment are selected such that the pitch values at the anchor points for the given segment are the same as the pitch values at the anchor points as determined in step 301. In such instance, the pitch values may be different at concatenation points between adjacent segments. For instance, as shown in FIG. 4, at anchor point t₃, the end point of segment S₁ has a pitch value that is different from the pitch value of the beginning point of segment S₂ (i.e., anchor point t₃ has two pitch values). In such instance, the pitch value at the anchor point t₃ can be set as the average of the two pitch values.

More specifically, in another exemplary embodiment of the invention, the pitch values at concatenation points between adjacent segments can be determined by averaging the actual pitch values at the end and start points of adjacent segments. The average pitch values at concatenation points are then used to linearly interpolate the pitch contour segments before and after the concatenation point. In other words, for each anchor point corresponding to a concatenation point between adjacent speech waveform segments, the constants aᵢ and bᵢ (Equation 3) can be selected such that the pitch value at the anchor point is equal to the average of the pitch values of adjacent segments at the concatenation point. It is to be understood that the averaging step is optional.

Once the initial pitch contour is determined, a smoothing filter is applied to the initial pitch contour to generate a smooth the pitch contour. Referring again to FIG. 3, an exemplary smoothing process generally includes applying a smoothing filter to the initial pitch contour to determine pitch values of the smoothed pitch contour at anchor points (step 303), and then determining a smooth contour between adjacent anchor points by linearly interpolating between the smooth pitch values of the anchor points (step 304).

In one exemplary embodiment, a smoothing filter is applied to the initial pitch contour by convolving the initial pitch contour (which comprises the linear pitch contour segments as determined from Equation 3) with the kernel function (Equation 1). The computation of the convolution integral (Equation 2), if done by “brute force” numerical methods, would be computationally expensive. However, in accordance with an exemplary embodiment of the invention, the computation of the convolution integral is performed analytically, wherein the filtering process is implemented in which an approximation is used to compute the convolution integral. More specifically, in one exemplary embodiment of the invention, the convolution integral is expressed analytically in closed form for each time segment between adjacent anchor points, and the smoothing filter is applied over the time segments of the initial pitch contour to determine pitch values for the smooth pitch contour at the anchor points.

More specifically, in one exemplary embodiment of the invention, the convolution integral is computed over each time segment between adjacent anchor points, and the results are summed, as follows:

$$\hat{g} ( t ) = {\sum }_{i = 1}^{n - 1} {\int }_{{t}_{i - 1}}^{{t}_{i}} ( {a}_{i} + {b}_{i} {t}^{′} ) h ( t - {t}^{′} ) ⅆ {t}^{′} \qquad ( 4 )$$

The integral is evaluated only at anchor points. At the j-th anchor point, we have:

$$\hat{g} ( {t}_{j} ) = {\sum }_{i = 1}^{j} {\int }_{{t}_{i - 1}}^{{t}_{i}} ( {a}_{i} + {b}_{i} {t}^{′} ) exp ( \frac{{t}^{′} - {t}_{j}}{{τ}_{c}} ) ⅆ {t}^{′} + {\sum }_{i = j + 1}^{n - 1} {\int }_{{t}_{i - 1}}^{{t}_{i}} ( {a}_{i} + {b}_{i} {t}^{′} ) exp ( \frac{{t}_{j} - {t}^{′}}{{τ}_{c}} ) ⅆ {t}^{′} \qquad ( 5 )$$

The expression (Equation (5)) is divided into two parts because in time segments that start before the j-th anchor point, the kernel function is an increasing exponential, and in segments after the j-th anchor point, the kernel function is a decreasing exponential. The integrals that appear in Equation (5) can be evaluated analytically, and the result is:

$$\begin{matrix}{\int }_{{t}_{i - 1}}^{{t}_{i}} ( {a}_{i} + {b}_{i} {t}^{′} ) exp ( \frac{{t}^{′} - {t}_{j}}{{τ}_{c}} ) ⅆ {t}^{′} = exp ( \frac{{t}_{i} - {t}_{j}}{{τ}_{c}} ) ( {a}_{i} + {b}_{i} ( {t}_{i} - {τ}_{c} ) ) {τ}_{c} - exp ( \frac{{t}_{i - 1} - {t}_{j}}{{τ}_{c}} ) ( {a}_{i} + {b}_{i} ( {t}_{i - 1} - {τ}_{c} ) ) {τ}_{c} \\ and & ( 6 ) \\ {\int }_{{t}_{i - 1}}^{{t}_{i}} ( {a}_{i} + {b}_{i} {t}^{′} ) exp ( \frac{{t}_{j} - {t}^{′}}{{τ}_{c}} ) ⅆ {t}^{′} = exp ( \frac{{t}_{j} - {t}_{i}}{{τ}_{c}} ) ( {a}_{i} + {b}_{i} ( {t}_{i} - {τ}_{c} ) ) {τ}_{c} - exp ( \frac{{t}_{j} - {t}_{i - 1}}{{τ}_{c}} ) ( {a}_{i} + {b}_{i} ( {t}_{i - 1} - {τ}_{c} ) ) {τ}_{c} & ( 7 )\end{matrix}$$

The closed-form expressions, the right-hand sides of Equations (6) and (7), can be substituted for the integrals in Equation 5, to yield a method for determining the smooth pitch contour at the anchor points without the need for numerical integration.

Thereafter, once the pitch values of the smooth pitch contour have been determined at the anchor points, the remainder of the smooth pitch contour is determined by linearly interpolating between anchor points with the smooth pitch values (step 304). More specifically, at other time points between each segment, the smoothed pitch contour function ĝ(t) is interpolated linearly, so that in the time interval tᵢ₋₁≦t≦tᵢ, the smooth pitch contour is determined as:

$$\hat{g} ( t ) = \hat{g} ( {t}_{i - 1} ) + \frac{t - {t}_{i - 1}}{{t}_{i} - {t}_{i - 1}} ( \hat{g} ( {t}_{i} ) - \hat{g} ( {t}_{i - 1} ) ) \qquad ( 8 )$$

FIG. 5 is an exemplary graphical diagram that illustrates a smoothed, continuous pitch contour that is determined by convolving the initial pitch contour (FIG. 4) with the exemplary kernel function (Equation 1) and linear interpolation using the methods of Equations 4-8. As depicted, the smooth pitch contour is smooth and does not contain discontinuities. Moreover, the smooth pitch contour closely tracks and does not deviate to far from the initial, non-smooth pitch. In this manner, the spectral pitch smoothing of the speech waveform segments does not lead to degradation of the naturalness and maintains the inherent prododsy characteristics of the concatenated speech segments.

It is to be understood that pitch smoothing methods described herein are not limited to concatenative speech synthesis but may be implemented with various types of TTS synthesis methods. For instance, the exemplary pitch smoothing methods may be implemented in formant synthesis applications for smoothing pitch contours that are predicted/estimated using rule-based or machine learning based methods. In such instance, an initial pitch contour for a target utterance having linear pitch contour segments between anchor points can be determined by performing text and prosody analysis on a text string to be synthesized. However, depending on the text and prosody methods and the available linguistic knowledge base, the predicted pitch contour may include pitch transients and discontinuities that may result in unnatural sounding synthesized speech. According, pitch smoothing methods may be applied to the predicted pitch contours to smooth the pitch contours and improve the quality of the synthesized signal.

Although illustrative embodiments have been described herein with reference to the accompanying drawings, it is to be understood that the invention is not limited to the precise system and method embodiments described herein, and that various other changes and modifications may be affected therein by one skilled in the art without departing form the scope or spirit of the invention. All such changes and modifications are intended to be included within the scope of the invention as defined by the appended claims.

1. A method for speech synthesis, comprising:
generating a sequence of phonetic units representative of a target utterance;
determining a pitch contour for the target utterance, the pitch contour comprising a plurality of linear pitch contour segments, wherein each linear pitch contour segment has start and end times at anchor points of the pitch contour;
filtering the pitch contour to determine pitch values of a smooth pitch contour at the anchor points; and
determining the smooth pitch contour between adjacent anchor points by linearly interpolating between the pitch values of the smooth pitch contour at the anchor points.

2. The method of claim 1, wherein determining a pitch contour for the target utterance comprises predicting pitch and duration values by linguistic analysis of textual data corresponding to the sequence of phonetic units.

3. The method of claim 1, wherein determining a pitch contour for the target utterance comprises:
selecting time points as the anchor points for the pitch contour,
determining a pitch value at each anchor point; and
determining the pitch contour between anchor points by linearly interpolating between the pitch values of the anchor points.

4. The method of claim 3, wherein selecting time points as the anchor points comprises selecting an anchor point at a boundary point between phonetic units in the sequence of phonetic units.

5. The method of claim 4, wherein the phonetic units include sub-phoneme units.

6. The method of claim 3, determining a pitch value at each anchor point comprises:
determining an actual pitch contour of a sequence of concatenated speech waveform segments representative of the sequence of phonetic units at the anchor points; and
determining the pitch value at each anchor point using the actual pitch values.

7. The method of claim 6, wherein the pitch values at the anchor points are determined using the actual pitch values and estimated pitch values.

8. The method of claim 6, wherein determining a pitch value at each anchor point comprises:
determining an average pitch value of an anchor point that corresponds to a concatenation point between concatenated speech waveform segments by averaging the pitch values at the end and start times of the concatenated speech waveform segments; and
setting the pitch values at the end and start times of the concatenated speech waveform segments to the average pitch value.

9. The method of claim 1, wherein filtering comprises convolving the pitch contour with a kernel function.

10. The method of claim 9, wherein the kernel function is a double exponential function expressed as h(τ)=e^{-|τ|/τ}_{c}.

11. The method of claim 9, wherein convolving comprises analytically determining a convolution integral over one or more of the linear pitch contour segments using a closed-form expression of the convolution integral to determine smooth pitch values at the anchor points without using numerical integration.

12. The method of claim 1, further comprising generating an acoustic waveform representation of the target utterance using the smooth pitch contour.

13. The method of claim 12, wherein generating an acoustic waveform comprises:
concatenating a plurality of speech waveform segments to generate a sequence of speech waveform segments corresponding to the sequence of phonetic units; and
adjusting pitch data of the speech waveform segments to fit the smooth pitch contour.

14. The method of claim 1, wherein the phonetic units comprise phonemes.

15. A program storage device readable by machine, tangibly embodying a program of instructions executable by the machine to perform speech synthesis, the method steps comprising:
generating a sequence of phonetic units representative of a target utterance;
determining a pitch contour for the target utterance, the pitch contour comprising a plurality of linear pitch contour segments, wherein each linear pitch contour segment has start and end times at anchor points of the pitch contour;
filtering the pitch contour to determine pitch values of a smooth pitch contour at the anchor points; and
determining the smooth pitch contour between adjacent anchor points by linearly interpolating between the pitch values of the smooth pitch contour at the anchor points.

16. A text-to-speech synthesis system, comprising:
a text processing system for processing textual data and phonetically transcribing the textual data into a sequence of phonetic units representative of a target utterance to be synthesized;
a prosody processing system for determining a pitch contour for the target utterance comprising a plurality of linear pitch contour segments having start and end times at anchor points of the pitch contour, and for determining a smooth pitch contour by filtering the pitch contour to determine pitch values of the smooth pitch contour at the anchor points, and linearly interpolating between the pitch values of the smooth pitch contour at the anchor points; and
a signal synthesizing system for generating an acoustic waveform representation of the target utterance using the smooth pitch contour for the target utterance.

17. The system of claim 16, further comprising:
a speech waveform database comprising recorded speech samples having speech waveform segments that are indexed to individual phonetic units;
a speech segment selection system for searching the speech waveform database and selecting speech waveform segments for the target utterance, which are contextually similar to the phonetic units.

18. The system of claim 17, wherein the speech waveform segments are indexed to corresponding prosody parameters including duration and pitch.

19. The system of claim 18, wherein the signal synthesizing system concatenates the speech waveform segments selected for the target utterance and adjusts prosody parameters of the selected speech waveform segments to fit the smooth pitch contour determined for the target utterance.

20. The system of claim 16, wherein the prosody processing system performs filtering by convolving the pitch contour with a kernel function, wherein the kernel function is a double exponential function expressed as h(τ)=e^{-|τ|/τ}^{_{c}}.

21. The system of claim 20, wherein the prosody processing system performs convolving by analytically determining a convolution integral over one or more of the linear pitch contour segments using a closed-form expression of the convolution integral to determine smooth pitch values at the anchor points without using numerical integration.

22. The system of claim 16, wherein the TTS system is a concatenative synthesis TTS system.

23. The system of claim 16, wherein the TTS system is a formant synthesis TTS system.
